(19) United States
(12) Patent Application Publication
(10) Pub. No.: US 2019/0169841 A1
(43) Pub. Date: Jun. 6, 2019

(54) WILD-FIRE PROTECTED SHED FOR STORAGE AND PROTECTION OF PERSONAL PROPERTY DURING WILD-FIRES

(71) Applicant: M-Fire Suppression, Inc., Carlsbad, CA (US)

(72) Inventor: Stephen Conboy, Carlsbad, CA (US)

(73) Assignee: M-Fire Suppression, Inc., Carlsbad, CA (US)

(21) Appl. No.: 15/925,793

(22) Filed: Mar. 20, 2018

Related U.S. Application Data
(63) Continuation-in-part of application No. 15/866,451, filed on Jan. 9, 2018.
Application No. 15/866,451 is a continuation-in-part of application No. 15/829,914, filed on Dec. 2, 2017, now Pat. No. 10,260,232.

(51) Int. Cl. E04B 1/94; E04B 1/76; E04B 2/70; E04H 9/14; E06B 5/16; E04F 13/14; E04D 11/02; H02S 40/38; F21S 9/03; A62C 2/06; A62C 3/02; A62C 3/00

(52) U.S. Cl. CPC E04B 1/944; H04B 1/38; E04B 1/762; E04B 1/942; E04B 2/70; E04H 9/14; E06B 5/16; E04F 13/141; E04D 11/02; H02S 40/38; F21S 9/032; A62C 2/06; A62C 3/0257; A62C 3/0214; A62C 3/002; E04B 1/7608

(57) ABSTRACT

A wild-fire protected shed structure for installation on a parcel of real property, or within a garage, and having a fire-protected internal storage space for storing and protecting diverse items of personal property during raging wild-fires. The wild-fire protected shed structure has a Class-A fire-protected wood-frame structure constructed from Class-A fire-protected lumber, and having an interior side and an exterior side. Radiant energy insulation is installed on the exterior side of said wood-frame structure, for insulation to radiant energy sources located outside of the wild-fire protective shed structure. Thermal energy insulation is applied to the interior side of the wood frame structure, to provide thermal energy insulation to the interior of the wild-fire protected shed structure to maintain the interior temperature relatively cool, despite extreme temperatures outside while wildfires are circling the wild-fire protected shed structure. Fiber cement panels are installed over the radiant energy insulation, to provide fire protection to the radiant energy insulation. A fire-door is installed in a front door way portion of the Class-A fire-protected wood-frame, providing essential fire-protection from the door way portion of the wildfire-protected shed. Also, a Class-A fire-protected steel roofing system is mounted on the roof portion of the wild-fire protected shed structure.

### RELATED CASES

The present patent application is a Continuation-in-Part (CIP) of pending application Ser. No. 15/866,451 filed Jan. 9, 2018, which is a Continuation-in-Part (CIP) of pending application Ser. No. 15/829,914 filed Dec. 2, 2017, both commonly owned by M-Fire Suppression, Inc., and incorporated herein by reference as if fully set forth herein.

### BACKGROUND OF INVENTION

### Field of Invention

The present invention is directed towards improvements in science and technology applied in the defense of private and public property, and human and animal life, against the ravaging and destructive forces of wild fires caused by lightning, accident, arson and terrorism.

### Brief Description of the State of Knowledge in the Art

The US federal government spent more than 3 billion US dollars on wild fire defense this year only to lose record numbers of acreage and homes. These figures relate solely to the US Forest Service costs and do not include figures from federal, state or local firefighting agencies. Over 8 million acres were scorched in 2017, a 50% increase in what is normally burned. Some estimates of the property damage in Northern California fires alone is $3 billion. The fires also killed more than 40 people and destroyed 8000 structures. Governor Brown of California is now asking President Trump for $7.5 billion dollars to rebuild Santa Rosa. However, the real problem is that the conventional fire suppression methods are not working as needed to protect neighborhoods, homes, business and human life from the raging forces of wild fire. More money is being spent and more people are being deployed, but the benefits are not being realized. There is a great need for better methods and apparatus for suppressing wild fires

FIG. 1 provides a table listing the primary conventional methods used for fighting and defending against wild fires and forest fires, alike: aerial water dropping illustrated in FIG. 2A; aerial fire retardant chemical (e.g. Phos-chek® Fire Retardant) dropping illustrated in FIGS. 2B1, 2B2 and 2B3; physical fire break by bulldozing, to stall the advance of wild fire; physical fire break by pre-burning, to stall the advance of wild fire; and chemical fire break by dropping fire retardant chemical such as Phos-chek® chemical over land, to stall the advance of wild fire. While these methods are used, the results have not been adequate in most instances where wild fires are raging across land under strong winds.

Recently, the State of California deployed its CAL FIRE™ mobile application for smartphones and other mobile computing devices, to provide users with notifications on where wild fires are burning at a given moment in time, the risks of wild fire in certain regions, ways of preparing for wild fires, and other useful information to help people stay out of harms way during a wild fire. However, this notification system in its current state does little to help home and business owners to proactively defend their homes and business against raging forces of wild fires in any meaningful way.

Also, while there are currently many garden sheds being sold at retail outlets to store articles and equipment, there are virtually useless when used to store valuable goods during a wildfire, essentially guaranteeing that anything contained inside during a wildfire will be completely burned to ashes.

Clearly, there is a great need and growing demand for new and improved methods of and apparatus for providing improved defense and protection against wild fires, while overcoming the shortcomings and drawbacks of prior art methods and apparatus.

### OBJECTS AND SUMMARY OF THE PRESENT INVENTION

Accordingly, a primary object of the present is to provide new and improved wild-fire protected shed structure for installation on a parcel of real property, or within a garage, and having a fire-protected internal storage space for storing and protecting diverse items of personal property during raging wild-fires.

Another object of the present invention is to provide such a wild-fire protected shed structure having a Class-A fire-protected wood-frame structure constructed from Class-A fire-protected lumber, and having an interior side and an exterior side, wherein radiant energy insulation is installed on the exterior side of the wood-frame structure, so as to provide insulation to radiant energy sources located outside of the wild-fire protective shed structure; and thermal energy insulation is applied to the interior side of the wood frame structure, so as to provide thermal energy insulation to the interior of the wild-fire protected shed structure to maintain the interior temperature relatively cool, despite extreme temperatures outside while wildfires are circling the wild-fire protected shed structure.

Another object of the present invention is to provide such a wild-fire protected shed structure, wherein fiber cement panels are installed over the radiant energy insulation, so as to provide fire protection to the radiant energy insulation, wherein a fire-door is installed in a front door way portion of the Class-A fire-protected wood-frame providing access to the fire-protected internal storage space, providing essential fire-protection from the door way portion of the wildfire-protected shed, and wherein a Class-A fire-protected roofing system is mounted on the roof portion of the wild-fire protected shed structure providing essential fire-protection from the roof side portion of the fire-protected shed structure.

Another object of the present invention is to provide method of and system and network for managing the supply, delivery and spray-application of environmentally-clean anti-fire (AF) liquid material on private and public properties to reduce the risks of damage and/or destruction to property and life caused by wild fires, while overcoming the shortcomings and drawbacks of prior art methods and apparatus.

Another object of the present is to provide method of reducing the risks of damage to private property due to wild fires by centrally managed application of AF chemical liquid spray to ground cover and building surfaces prior to arrival of the wild fires.

Another object of the present is to provide method of reducing the risks of damage to private property due to wild fires using a global positioning satellite (GPS) system and mobile communication messaging techniques, to help direct the application of AF chemical liquid prior to the arrival of wild wires.

Another object of the present invention is to provide a new and improved system for wild fire suppression and home defense system, wherein each home defense spray system includes a GPS-tracking and radio-controlled circuit board to remotely monitor the location of each location-deployed home defense spray system and automatically monitor the anti-fire chemical liquid level in its storage tank, and automatically generate electronic refill orders sent to the command center, so that a third-party service can automatically replenish the tanks of such home-based systems with anti-fire liquid when the fluid level falls below a certain level in the GPS-tracked tank.

Another object of the present invention is to provide a new and improved system for wild fire suppression and home defense system, wherein the mobile application supporting the following functions: (i) sends automatic notifications from the command center to home owners with the mobile application, instructing them to spray their property and home at certain times with anti-fire chemical liquid in their tanks; (ii) the system will automatically monitor consumption of sprayed AF chemical liquid and generate auto-replenish order via its onboard GSM-circuits so as to achieve compliance with the home spray-based wild-fire-defense program, and report anti-fire liquid levels in each home-owner tank; and (iii) show status of wild fire risk in the region, and actions to the taken before wild fire outbreak.

Another object of the present invention is to provide a wireless system for managing the supply, delivery and spray-application of environmentally-clean anti-fire (AF) liquid on private and public property to reduce the risks of damage and/or destruction caused by wild fires.

Another object of the present invention is to provide a new and improved system for spraying a defensive path around vulnerable neighborhoods out in front of wild fires to make sure that an environmentally-safe fire break, created by the spray application of anti-fire (AF) liquid, defends homes from the destructive forces of raging wild fires.

Another object of the present invention is to provide a new and improved system and method of mitigating the damaging effects of wild fires by spraying environmentally-clean anti-fire (AF) chemical liquid in advance of wild fires, that do not depend on water to extinguish fire, such that, even after a month or two after spray application on dry brush around the neighborhood, the anti-fire chemical continues to work by stalling the ability of a fire to advance and consume homes.

Another object of the present invention is to provide new and improved methods of and apparatus for protecting wood-framed buildings from wild fires by automatically spraying water-based environmentally clean anti-fire chemical liquid over the exterior surfaces of the building, surrounding ground surfaces, shrubs, decking and the like, prior to wild fires reaching such buildings.

Another object of the present invention is to provide a new personal property protection system employing wild-fire protected sheds for installation on a parcel of real property, or within a garage, for storage and protection of personal property during wild-fires.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a table listing conventional prior art methods for fighting and defending against wild fires including (i) aerial water drop methods using airplanes and helicopters, (ii) aerial fire retardant chemical (e.g. Phos-Chek® Fire Retardant) drop using airplanes and helicopters, (iii) physical fire breaks formed by bulldozing land and other landscaping methods to remove combustible vegetation from the land, (iv) physical fire breaks by pre-burning combustible material on the land, and (v) chemical fire break by fire retardant chemical drop;

FIG. 2A is a first image illustrating a prior art method of wild fire suppression involving an airplane dropping water on a wild fire from the sky;

FIG. 2B is a second image illustrating a prior art method of wild fire suppression involving an airplane dropping chemical fire retardant (e.g. Phoscheck) on a wild fire from the sky;

FIG. 3A is a graphical image showing a house on a parcel of private property;

FIG. 3B is a graphical image showing a first wood shed for the storage of equipment, articles and other forms of personal property;

FIG. 3C is a graphical image showing a second wood shed for the storage of personal property and performing garden related activities;

FIG. 4 is schematic representation of the wireless system network of the present invention designed for managing the supply, delivery and spray-application of environmentally-clean anti-fire (AF) liquid on private and public property to reduce the risks of property damage and/or destruction and harm to life caused by wild fires, and shown comprising GPS-tracked anti-fire (AF) liquid spray ground vehicles, GPS-tracked anti-fire liquid spray air vehicles, GPS-tracked anti-fire liquid spray backpack systems for spraying houses and surrounding properties, GPS-tracked anti-fire liquid spraying systems for spraying private real property and buildings, GPS-tracked liquid spraying systems for spraying public real property and buildings, mobile computing systems running the mobile application of the present invention and used by property owners, residents, fire departments, insurance underwriters, government officials, medical personal and others, remote data sensing and capturing systems for remotely monitoring land and wild fires wherever they may break out, a GPS system for providing GPS-location services to each and every system components in the system network, and one or more data center containing clusters of web, application and database servers for supporting wire wild alert and notification systems, and microservices configured for monitoring and managing the system and network of GPS-tracking anti-fire liquid spraying systems and mobile computing and communication devices configured in accordance with the principles of the present invention;

FIG. 5A is a perspective view of an exemplary mobile computing device deployed on the system network of the present invention, supporting (i) the mobile anti-fire spray management application of the present invention deployed as a component of the system network of the present invention as shown in FIGS. 12 through 13D, as well as (ii) conventional wildfire alert and notification systems as shown in FIGS. 3A through 3E;

FIG. 5B shows a system diagram for an exemplary mobile client computer system deployed on the system network of the present invention;

FIG. 6 is a perspective view of the house in FIG. 3A, on which property the fire-protected shed structure of the present invention is installed;

FIG. 7 is a perspective view of the fire-protected shed structure of the present invention installed on a parcel of real property, and a GPS-tracked anti-fire liquid spraying system of the present invention located outside the shed structure;

FIG. 8 is an elevated front perspective view of the fire-protected shed structure of the present invention, during the final stages of construction with its front fire-rated steel door removed off its hinges to permit viewing to the interior of the shed structure;

FIG. 9A is a first perspective view of the Class-A fire-protected wood-frame structure used to construct the fire-protected shed structure of the present invention during construction, without any sheathing installed on either side of the wood framing;

FIG. 9B is a second perspective view of the Class-A fire-protected wood-frame structure used to construct the fire-protected shed structure of the present invention during construction, without any sheathing installed on either side of the wood framing;

FIG. 9C is a first perspective view of the Class-A fire-protected wood-frame structure used to construct the fire-protected shed structure of the present invention during construction, with metal reflective sheathing installed on the exterior side of the wood framing, but without any interior paneling applied, or roofing system installed;

FIG. 9D is a second perspective view of the interior of the fire-protected shed structure of the present invention during construction, with metal reflective sheathing installed on the exterior side of the wood framing, but without any interior paneling applied, or roofing system installed;

FIG. 9E is a third perspective view of the interior of the fire-protected shed structure of the present invention during construction, with metal reflective sheathing installed on the exterior side of the wood framing, and some fiberglass mat gypsum sheathing being applied to the interior side of the wood frame structure during the construction phase of the shed structure;

FIG. 9F is a perspective view of the exterior of the fire-protected shed structure of the present invention during construction, with exterior cement panel siding being applied to the exterior of the shed structure;

FIG. 9G is a perspective view of the front portion of the fire-protected shed structure of the present invention during construction, with exterior cement panel siding completely applied to the exterior of the shed structure, with front steel door installed on its hinges;

FIG. 9H is a perspective view of the front portion of the fire-protected shed structure of the present invention during construction, with trim applied to the exterior of the shed structure;

FIG. 10A is a schematic illustration of the multi-layered wall construction of the fire-protected shed structure of the present invention, shown comprising (i) fiberglass mat gypsum sheathing mounted upon (ii) a 2×4 Class-A fire-protected stud-based wood frame walls, (iii) a metal-foil heat reflective layer applied to the exterior surface of the wood-framed walls, and (iv) fiber cement paneling applied over the metal-foil radiation-reflective layer;

FIG. 10B is a schematic illustration of the multi-layered roof construction of the fire-protected shed structure of the present invention, shown comprising (i) a wood framed roof structure made from 2×6 Class-A fire-protected wood joists, (ii) a layer of Class-A fire-protected plywood mounted on the wood-framed roof structure, (iii) a layer of metal-foil heat reflective layer applied over the Class-A fire-protected plywood, and (iv) a Tilcor® multi-layered roofing system mounted over the metal-foil radiation-reflective layer;

FIG. 10B1 is a schematic illustration showing the multiple layers used to form the roofing system shown in FIG. 10B, comprising (i) a base steel layer, to which a first and second zincalume layers are bonded, (ii) primer layers applied to the first and second zincalume layers, (iii) an acrylic base coat applied over the top primer layer; (iv) a natural stone chip layer applied over the acrylic base coat, and (v) an acrylic overglaze applied over the natural stone chip layer;

FIG. 10C is a schematic illustration of the multi-layered floor construction of the fire-protected shed structure of the present invention, shown comprising (i) a wood frame flooring structure formed from Class-A fire-protected 2×6 joists, covered with a Class-A fire-protected plywood flooring panel, and supported on (ii) a concrete base structure supported on the ground surface;

FIG. 10D is a schematic illustration of the fire-rated door construction used in the fire-protected shed structure of the present invention;

FIG. 11 is an electrical schematic diagram of the solar-powered LED lighting system and GPRS/GSM transceiver and input sensors supported within the fire-protected shed structure of the present invention;

FIG. 12 is a perspective view of a mobile GPS-tracked anti-fire (AF) liquid spraying system supported on a set of wheels, with integrated supply tank and rechargeable-battery operated electric spray pump, for deployment at private and public properties having building structures, for spraying the same with environmentally-clean anti-fire (AF) liquid in accordance with the principles of the present invention; and

FIG. 13 is a schematic representation of the GPS-tracked mobile anti-fire (AF) chemical liquid spraying system shown in FIG. 6A, comprising a GPS-tracked and remotely-monitored AF chemical liquid spray control subsystem interfaced with a micro-computing platform for monitoring the spraying of AF chemical liquid from the system when located at specific GPS-indexed location coordinates, and automatically logging and recording such AF spray application operations within the network database system.

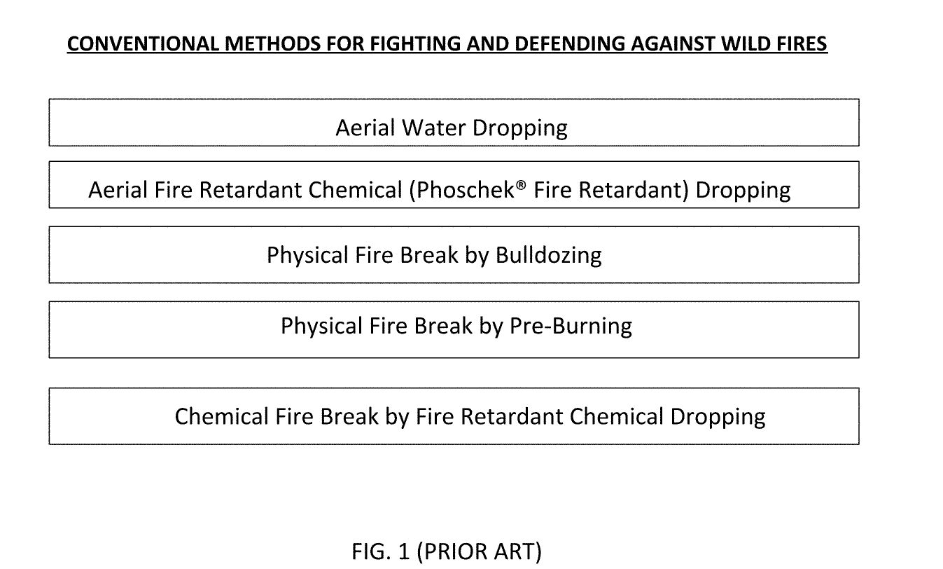

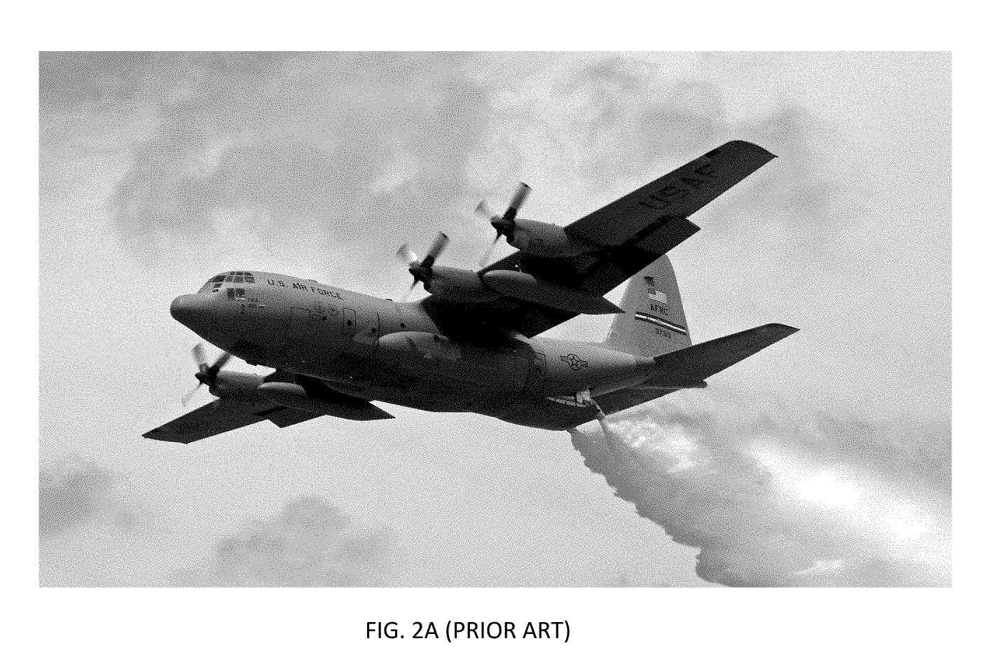

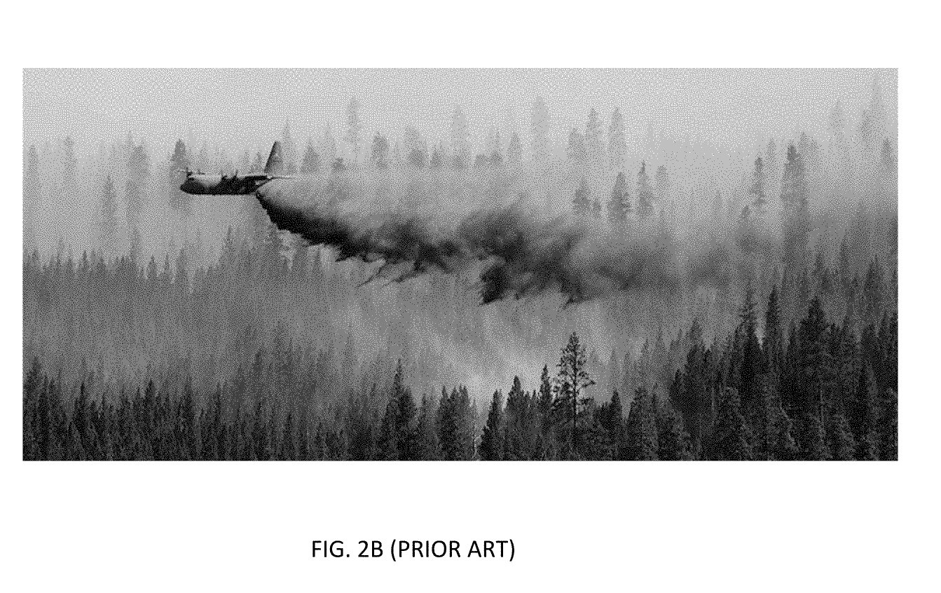

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

Wireless System Network for Managing the Supply, Delivery and Spray-Application of Environmentally-Clean Anti-Fire (AF) Liquid on Private and Public Property to Reduce the Risks of Damage and/or Destruction Caused by Wild Fires

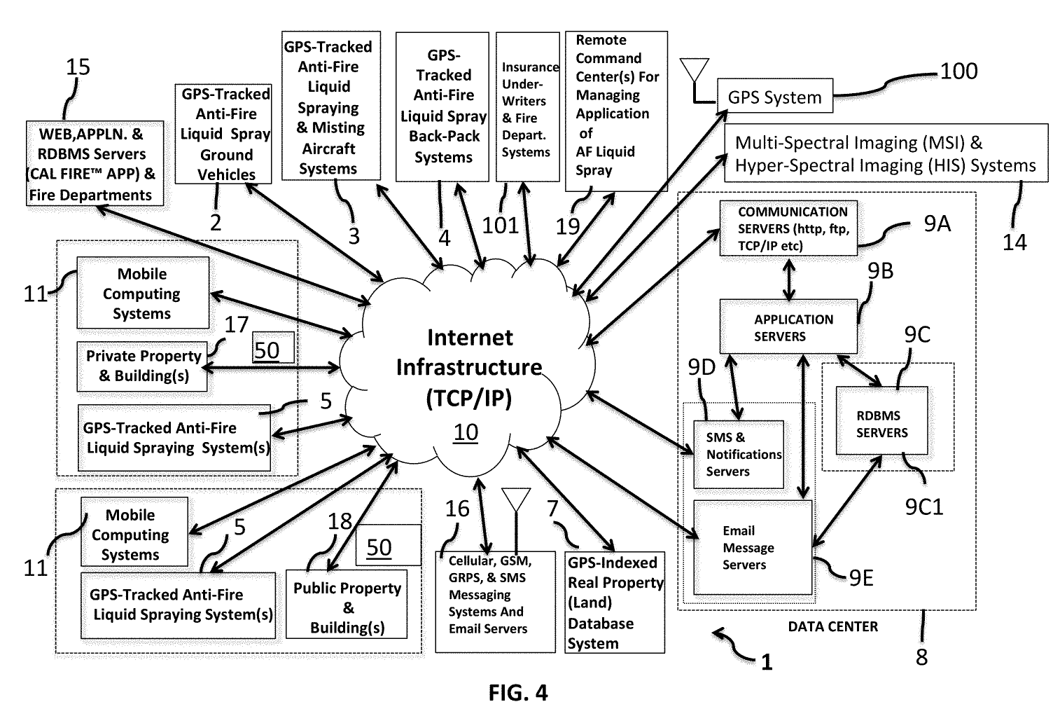

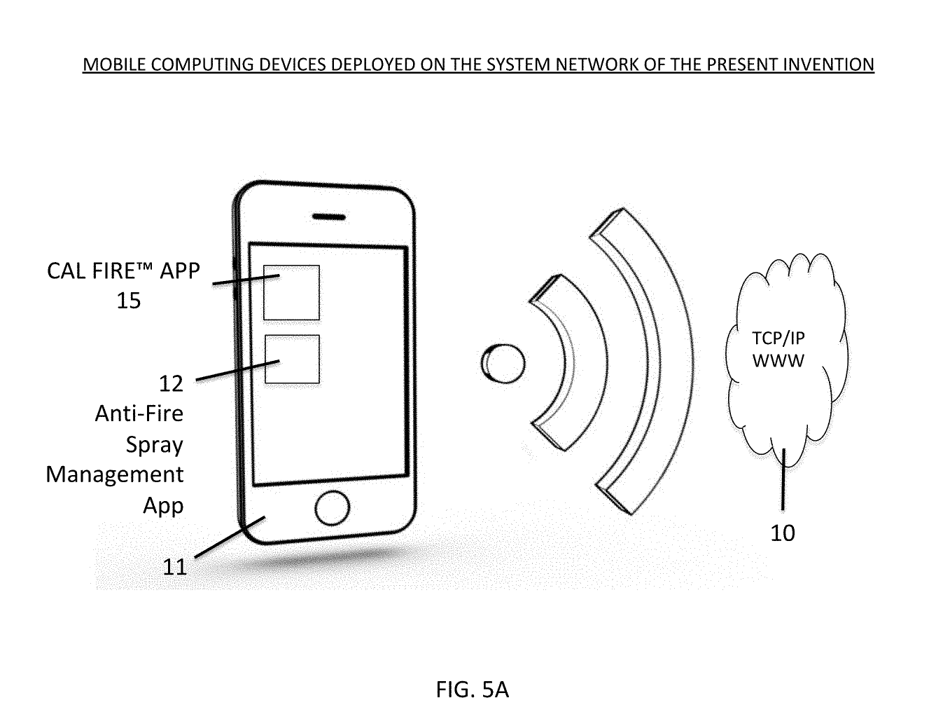

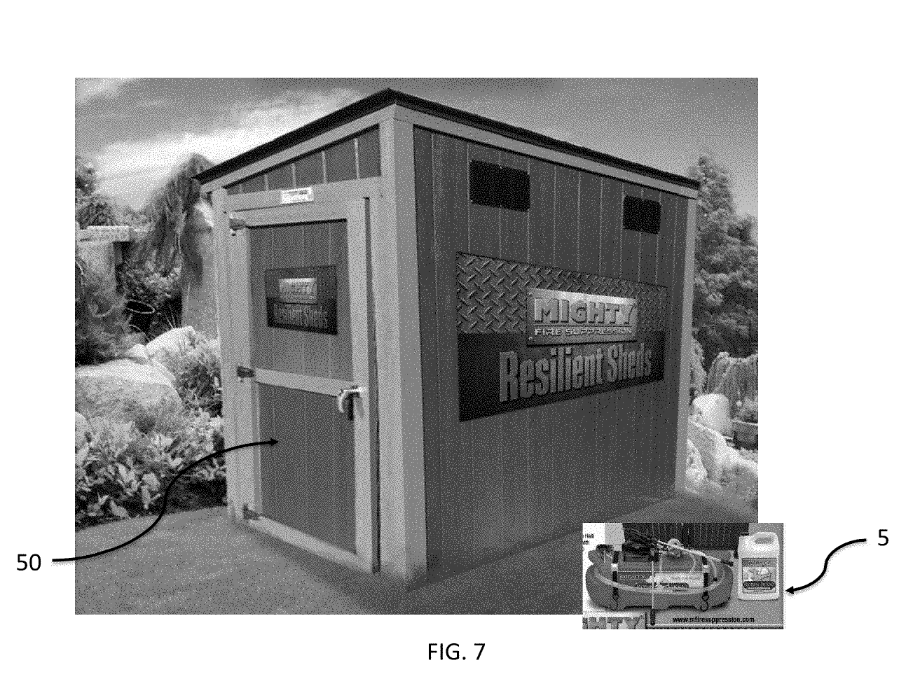

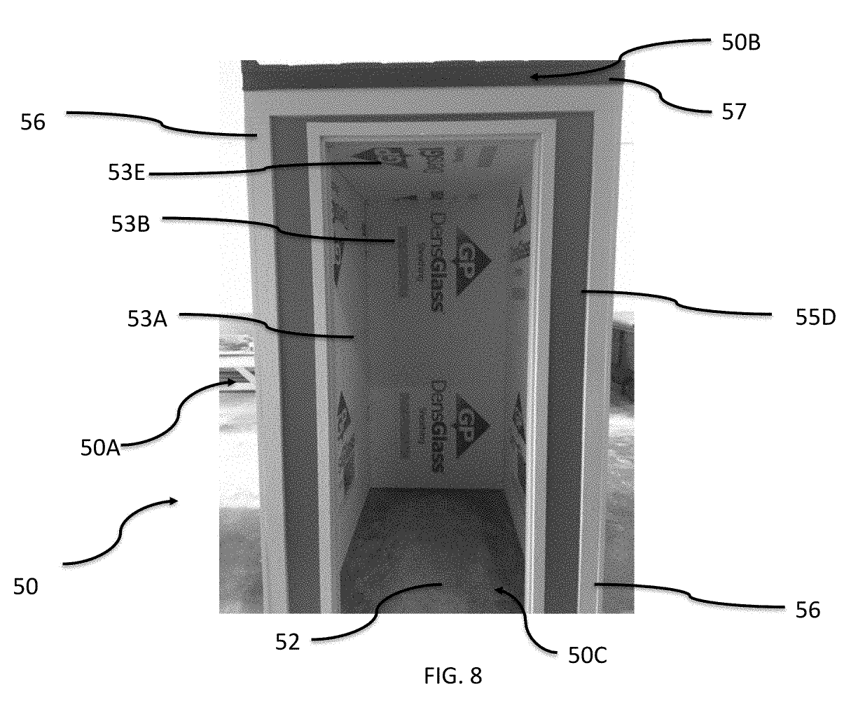

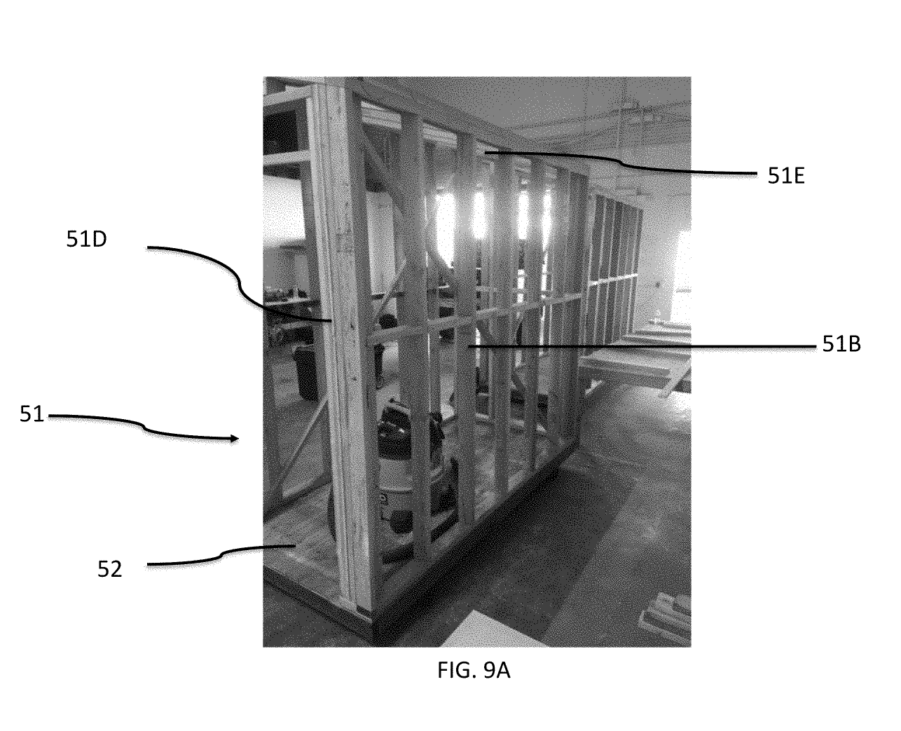

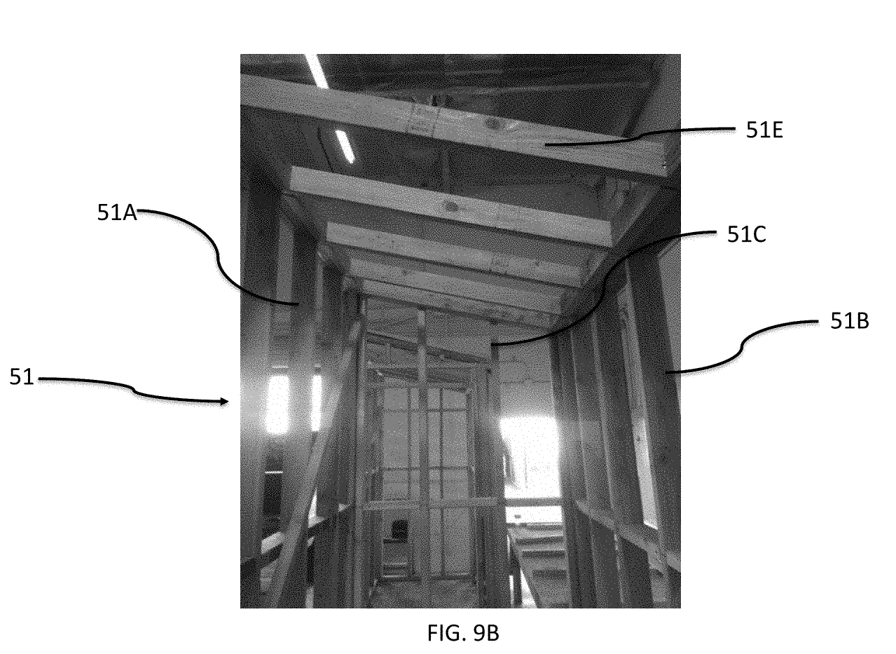

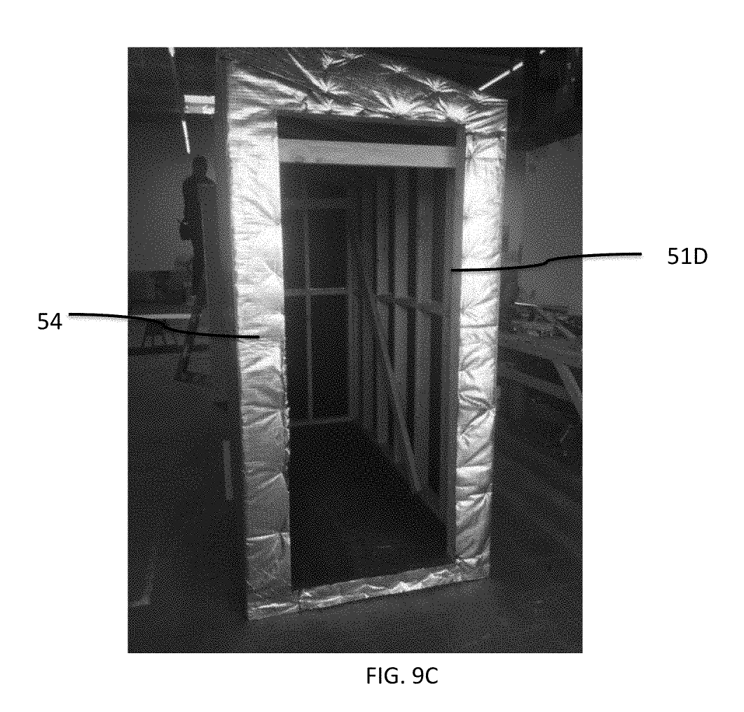

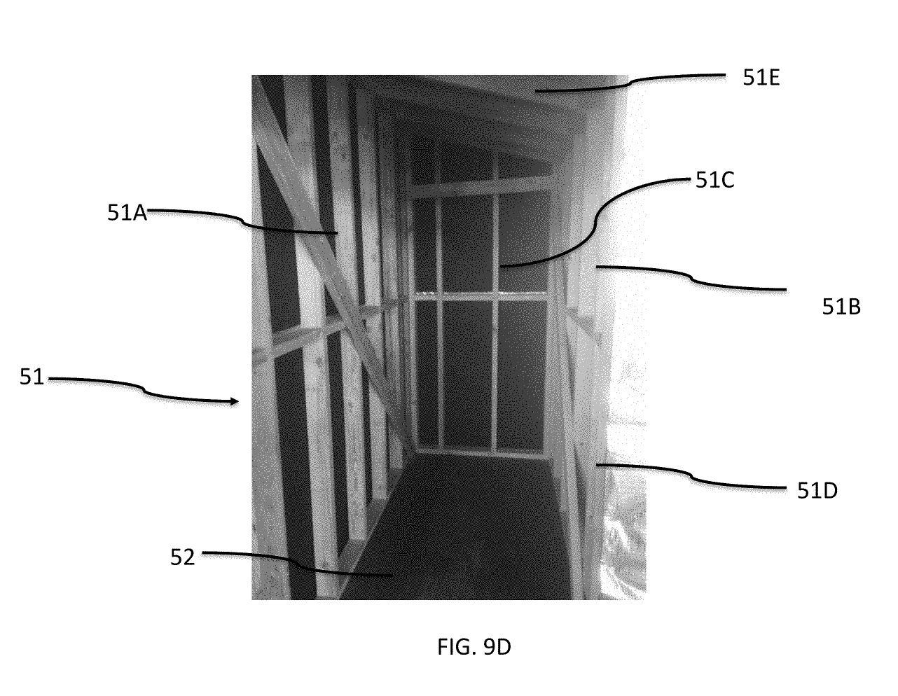

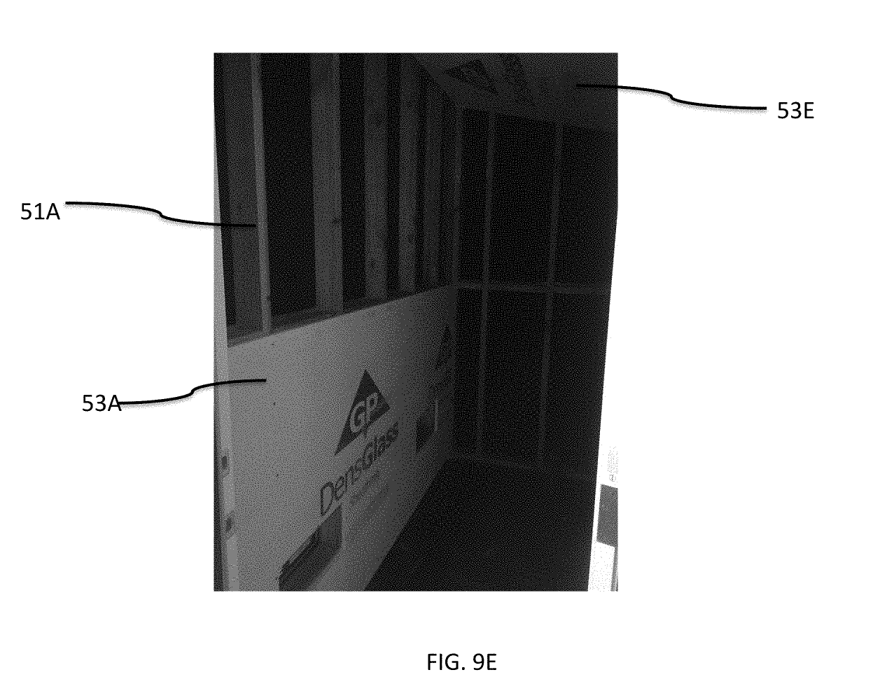

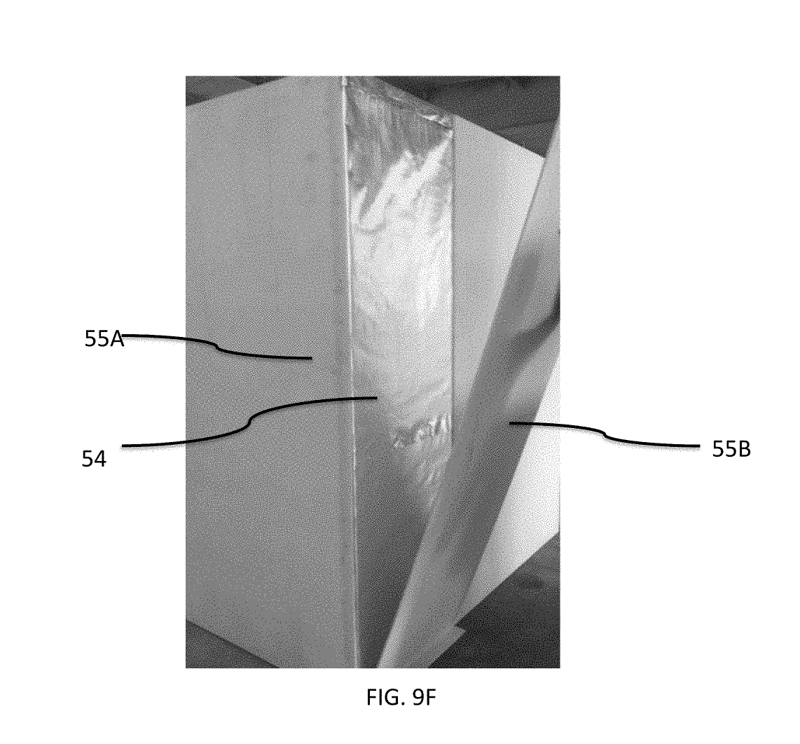

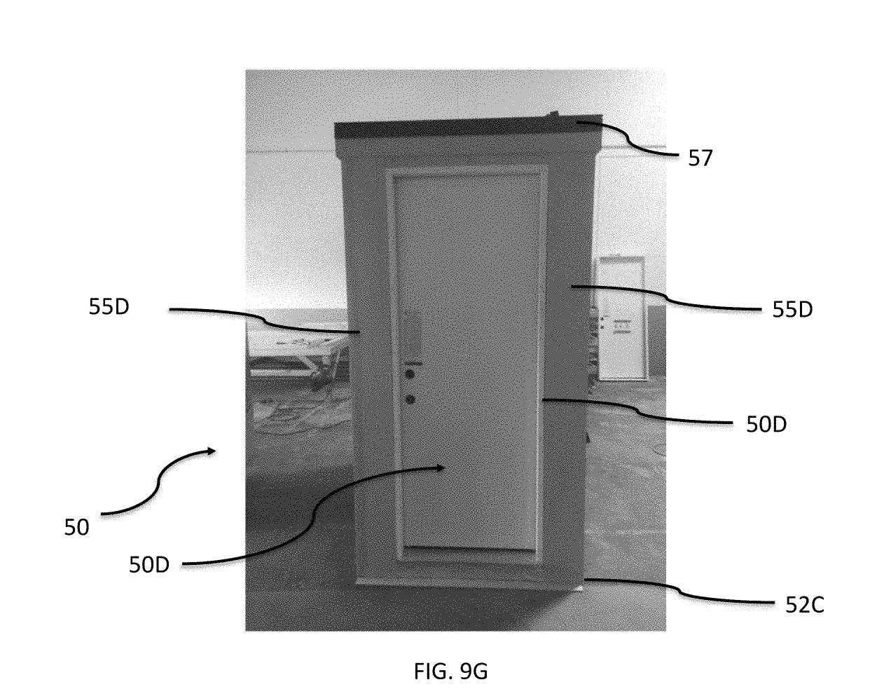

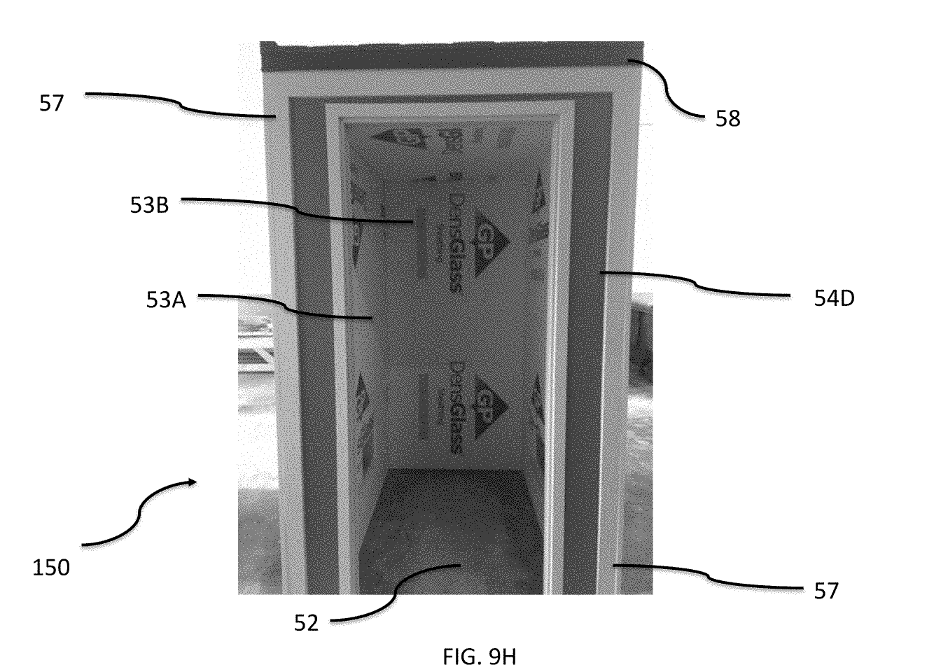

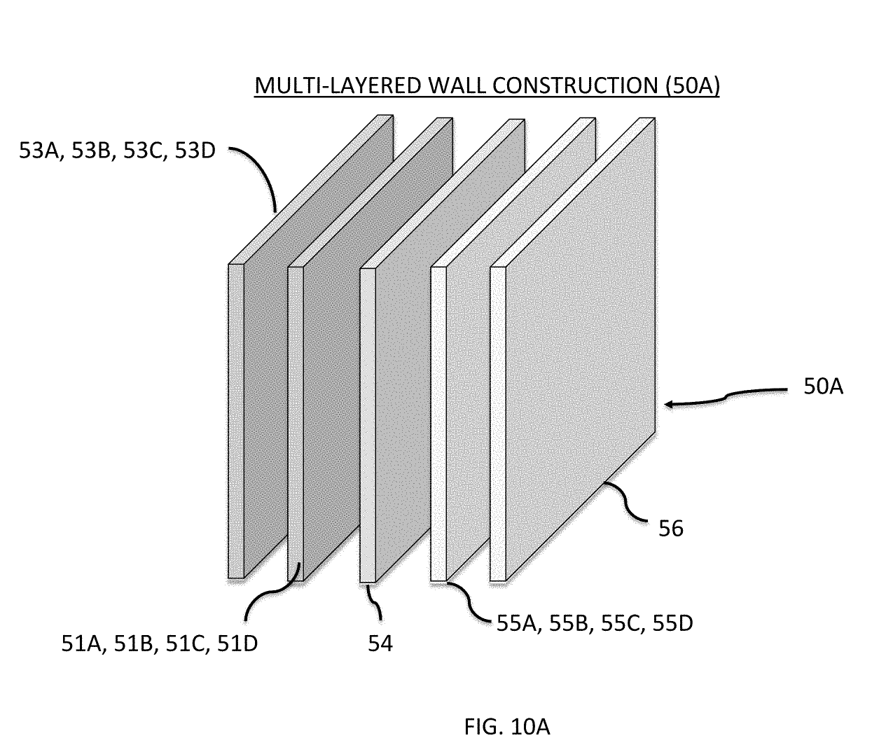

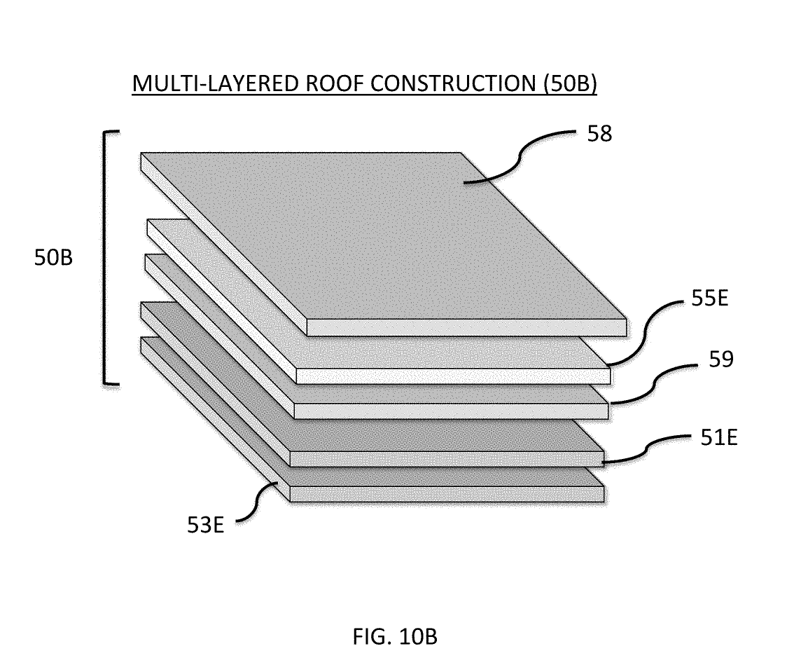

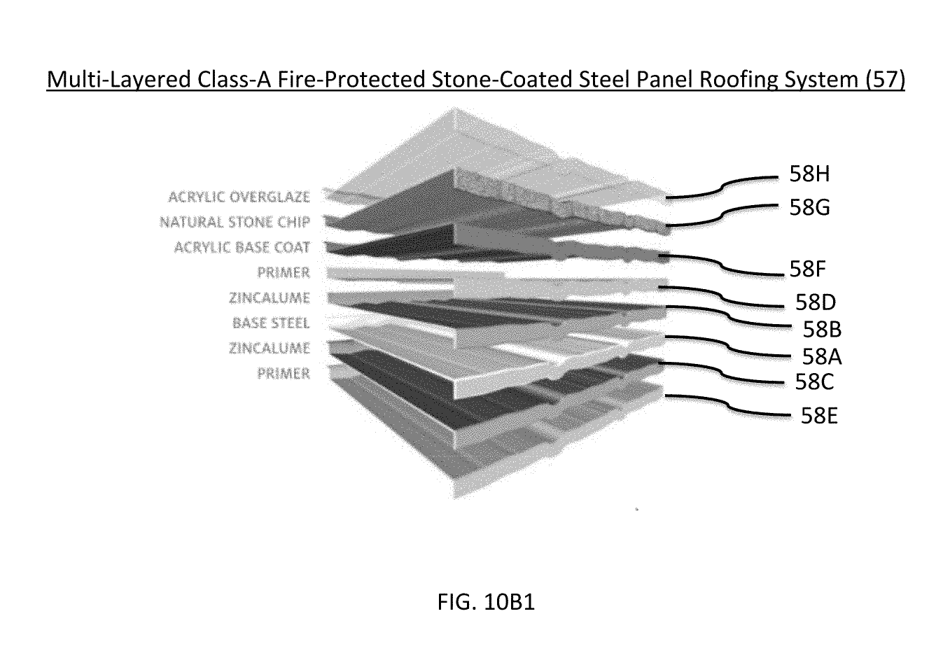

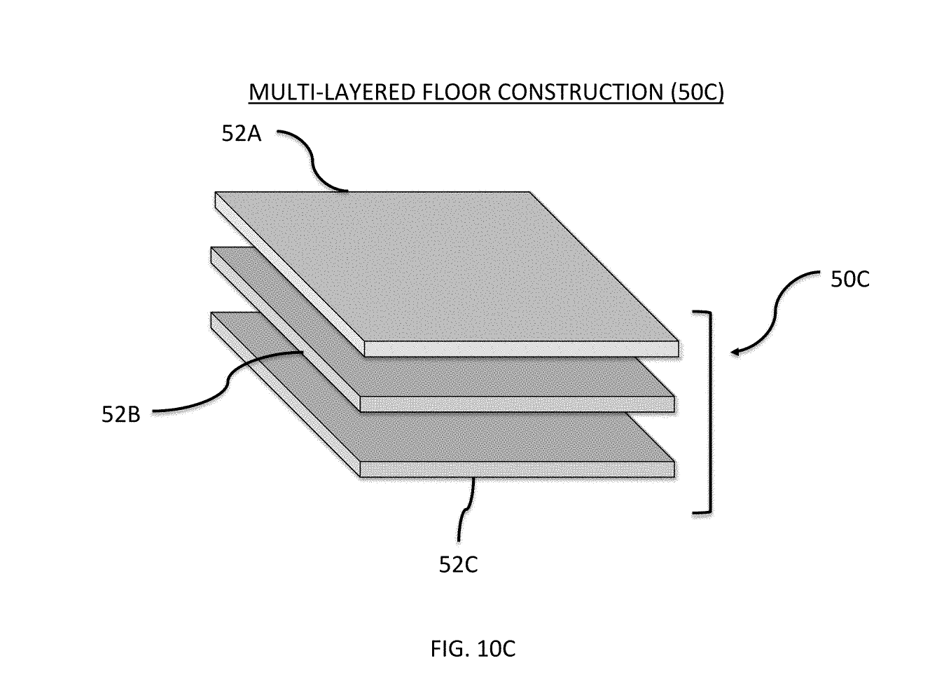

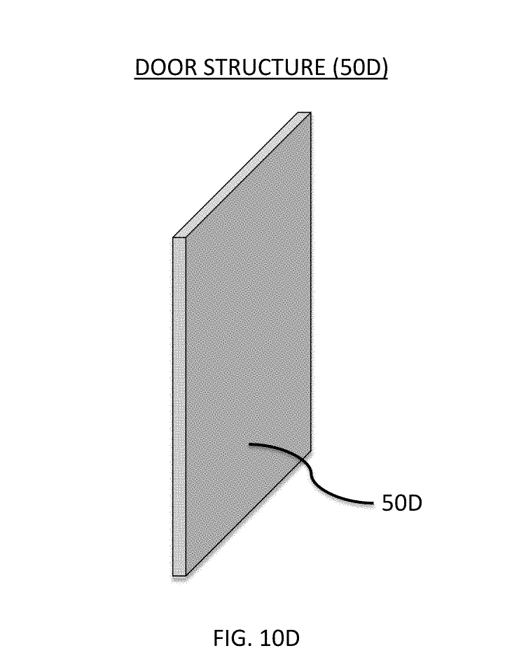

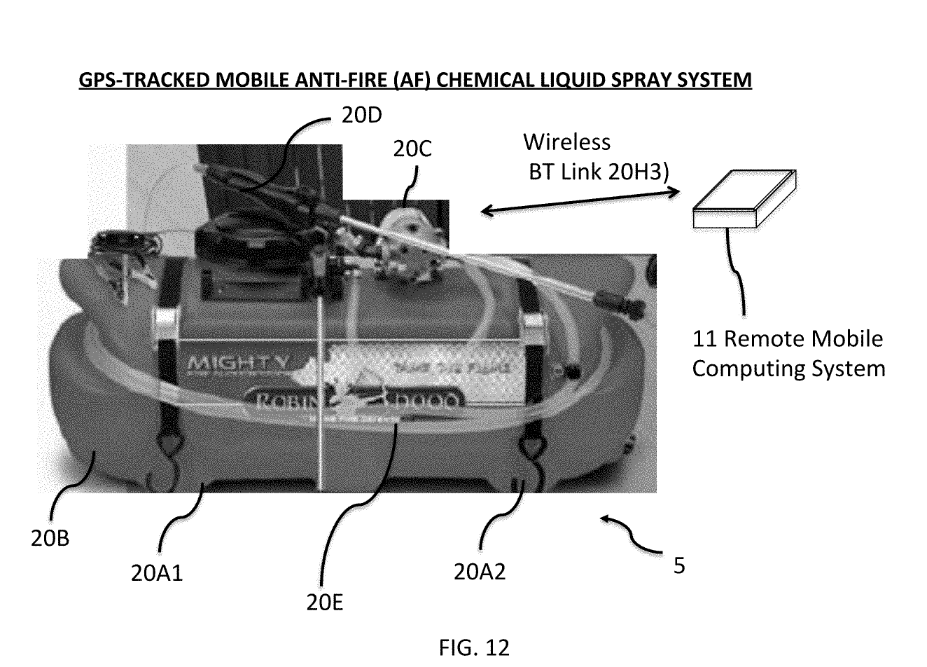

FIG. 4 shows the wireless system network of the present invention 1 designed for managing the supply, delivery and spray-application of environmentally-clean anti-fire (AF) liquid on private and public property to reduce the risks of damage and/or destruction caused by wild fires. As shown, the wireless system network 1 comprises a distribution of system components, namely: GPS-tracked anti-fire (AF) liquid spray ground vehicles 2 (e.g. all terrain vehicles or ATVs) as shown in FIGS. 7A and 7B, and 10A and 10B, for applying AF chemical liquid spray (e.g. Hartindo AF31 fire inhibitor chemical from Hartindo Chemical, Indonesia) from the ground to ground surfaces, brush, and other forms of organic material; GPS-tracked anti-fire liquid spray air-based vehicles 3 as shown in FIGS. 9A, 9B, and 8A, 8B for applying AF chemical liquid spray (e.g. Hartindo AF31 fire inhibitor chemical liquid) from the air to ground surfaces, brush, bushes and other forms of organic material; GPS-tracked mobile anti-fire liquid spraying systems 4 (e.g. including wheel supported, and backpack-carried systems) as shown in FIGS. 12A and 12B for applying AF chemical liquid spray (e.g. Hartindo AF31 fire inhibitor chemical liquid) to ground surfaces, brush, bushes, decks, houses, buildings, and other forms of organic material and property surrounding houses; GPS-tracked/GSM-linked anti-fire liquid spraying systems 5 for applying AF chemical liquid spray (e.g. Hartindo AF31 fire inhibitor chemical liquid) to private real property, buildings and surrounding areas; GPS-tracked/GSM-linked liquid spraying systems 6 for applying AF chemical liquid spray (e.g. Hartindo AF31 fire inhibitor chemical liquid) to public real property and buildings and surrounding properties; a GPS-indexed real-property (land) database system 7 for storing the GPS coordinates of the vertices and maps of all land parcels, including private property and building 17 and public property and building 18, situated in every town, county and state in the region over which the system network 1 is used to manage wild fires as they may occur; a cellular phone, GSM, and SMS messaging systems and email servers, collectively 16; and one or more data centers 8 for monitoring and managing GPS-tracking/GSM-linked anti-fire (AF) liquid supply and spray systems, including web servers 9A, application servers 9B and database servers 9C (e.g. RDBMS) operably connected to the TCP/IP infrastructure of the Internet 10, and including a network database 9C1, for monitoring and managing the system and network of GPS-tracking anti-fire liquid spraying systems and various functions supported by the command center 19, including the management of wild fire suppression and the GPS-guided application of anti-fire (AF) chemical liquid over public and private property, as will be described in greater technical detail hereinafter. As shown, each data center 8 also includes an SMS server 9D and an email message server 9E for communicating with registered users on the system network 1 who use a mobile computing device (e.g. an Apple® iPhone or iPad tablet) 11 with the mobile application 12 installed thereon and configured for the purposes described herein. Such communication services will include SMS/text, email and push-notification services known in the mobile communications arts.

As shown in FIG. 4, the GPS-indexed real-property (land) database system 7 will store the GPS coordinates of the vertices and maps of all land parcels contained in every town, county and state of the region over which the system network is deployed and used to manage wild fires as they may occur. Typically, databases and data processing methods, equipment and services known in the GPS mapping art, will be used to construct and maintain such GPS-indexed databases 7 for use by the system network of the present invention, when managing GPS-controlled application of clean anti-fire (AF) chemical liquid spray and mist over GPS-specified parcels of land, at any given time and date, under the management of the system network of the present invention. Examples of such GPS-indexed maps of land parcels are reflected by the task report shown in FIG. 16, and examples of GPS-indexed maps are shown in the schematic illustrations depicted in FIGS. 18, 20, 22 and 24.

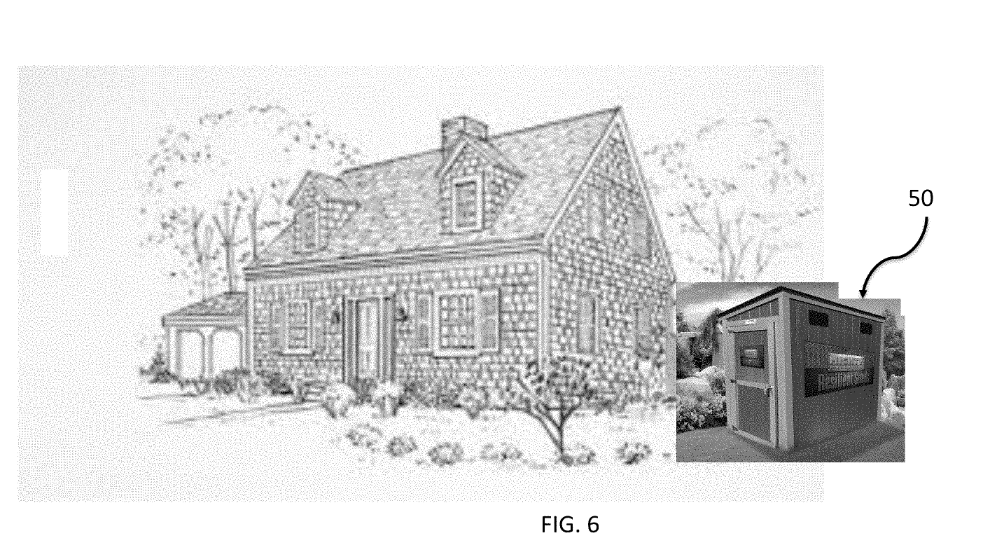

As shown in FIG. 4, the system network 1 also includes a GPS system 100 for transmitting GPS reference signals transmitted from a constellation of GPS satellites deployed in orbit around the Earth, to GPS transceivers installed aboard each GPS-tracking ground-based or air-based anti-fire (AF) liquid misting/spraying system of the present invention, shown in FIGS. 6A through 10B, as part of the illustrative embodiments. From the GPS signals it receives, each GPS transceiver aboard such AF liquid spraying/misting systems is capable of computing in real-time the GPS location of its host system, in terms of longitude and latitude. In the case of the Empire State Building in NYC, N.Y., its GPS location is specified as: N40° 44.9064′, W073° 59.0735′; and in number only format, as: 40.748440, −73.984559, with the first number indicating latitude, and the second number representing longitude (the minus sign indicates “west”).

As shown, the system network 1 further includes multi-spectral imaging (MSI) systems and/or hyper-spectral-imaging (HSI) systems 14 for remotely data sensing and gathering data about wild fires and their progress. Such MSI and HSI systems may be space/satellite-based and/or drone-based (supported on an unmanned airborne vehicle or UAV). Drone-based systems can be remotely-controlled by a human operator, or guided under an artificial intelligence (AI) navigation system. Such AI-based navigation systems may be deployed anywhere, provided access is given to such remote navigation system the system network and its various systems. Typically, the flight time will be limited to under 1 hour using currently available battery technology, so there will be a need to provide provisions for recharging the batteries of such drones/UASs in the field, necessitating the presence of human field personnel to support the flight and remote data sensing and mapping missions of each such deployed drone, flying about raging wild fires, in connection with the system network of the present invention.

During each wild fire data sensing and mapping mission, carried out by such UAS, a series of MSI images and HSI images can be captured during a wild fire, and mapped to GPS-specific coordinates, and this mapped data can be transmitted back to the system network for storage, analysis and generation of GPS-specified flight plans for anti-fire (AF) chemical liquid spray and misting operations carried out using the methods illustrated in FIGS. 17, 18, 19A and 19B seeking to stall and suppress such wild fires, and mitigate risk of damage to property and harm to human and animal life.

A suite of MSI and HSI remote sensing and mapping instruments and technology 14, currently being used by the US Geological Survey (USGS) Agency, can be used to collect, monitor, analyze, and provide science about natural resource conditions, issues, and problems on Earth. It is an object of the present invention to exploit such instruments and technology when carrying out and practicing the various methods of the present invention disclosed herein. These MSI/HSI remote sensing technologies 14 include: MODIS (Moderate Resolution Imaging Spectro-radiometer) satellite system for generating MODIS imagery subsets from MODIS direct readout data acquired by the USDA Forest Service Remote Sensing Applications Center, to produce satellite fire detection data maps and the like https://fsapps.nwcg.gov/afm/activefiremaps.php; the World View 2 Satellite System manufacture from the Ball Aerospace & Technologies and operated by DigitalGlobe, for providing commercially available panchromatic (B/W) imagery of 0.46 meter resolution, and eight-band multi-spectral imagery with 1.84 meter resolution; Octocopter UAS (e.g. OnyxStar Hyra-12 heavy lifting drone) supporting MSI and HSI camera systems for spectral imaging applications, http://www.onyxstar.net and http://www.genidrone.com; and SenseFly eBee SQ UAS for capturing and mapping high-resolution aerial multi-spectral images https://www.sensefly.com/drones/ebee-sq.html.

Any one or more of these types of remote data sensing and capture instruments, tools and technologies can be integrated into and used by the system network 1 for the purpose of (i) determining GPS-specified flight/navigation plans for GPS-tracked anti-fire (AF) chemical liquid spraying and misting aircraft and ground-based vehicle systems, and (ii) practicing the various GPS-guided methods of wild fire suppression described in detail in pending U.S. patent application Ser. No. 15/866,451, incorporated herein by reference.

### Specification of the Network Architecture of the System Network of the Present Invention

FIG. 4 illustrates the network architecture of the system network 1 implemented as a stand-alone platform deployed on the Internet. As shown, the Internet-based system network comprises: cellular phone and SMS messaging systems and email servers 16 operably connected to the TCP/IP infrastructure of the Internet 10; a network of mobile computing systems 11 running enterprise-level mobile application software 12, operably connected to the TCP/IP infrastructure of the Internet 10; an array of mobile GPS-tracked anti-fire (AF) liquid spraying systems (20, 30, 40, 50), each provided with GPS-tracking and having wireless internet connectivity with the TCP/IP infrastructure of the Internet 10, using various communication technologies (e.g. GSM, BlueTooth, WIFI, and other wireless networking protocols well known in the wireless communications arts); and one or more industrial-strength data center(s) 8, preferably mirrored with each other and running Border Gateway Protocol (BGP) between its router gateways, and operably connected to the TCP/IP infrastructure of the Internet 10.

As shown in FIG. 4, each data center 8 comprises: the cluster of communication servers 9A for supporting http and other TCP/IP based communication protocols on the Internet (and hosting Web sites); a cluster of application servers 9B; the cluster of RDBMS servers 9C configured within a distributed file storage and retrieval ecosystem/system, and interfaced around the TCP/IP infrastructure of the Internet well known in the art; the SMS gateway server 9D supporting integrated email and SMS messaging, handling and processing services that enable flexible messaging across the system network, supporting push notifications; and the cluster of email processing servers 9E.

Referring to FIG. 4, the cluster of communication servers 9A is accessed by web-enabled mobile computing clients 11 (e.g. smart phones, wireless tablet computers, desktop computers, computer workstations, etc) used by many stakeholders accessing services supported by the system network 1. The cluster of application servers 9A implement many core and compositional object-oriented software modules supporting the system network 1. Typically, the cluster of RDBMS servers 9C use SQL to query and manage datasets residing in its distributed data storage environment, although non-relational data storage methods and technologies such as Apache's HaDoop non-relational distributed data storage system may be used as well.

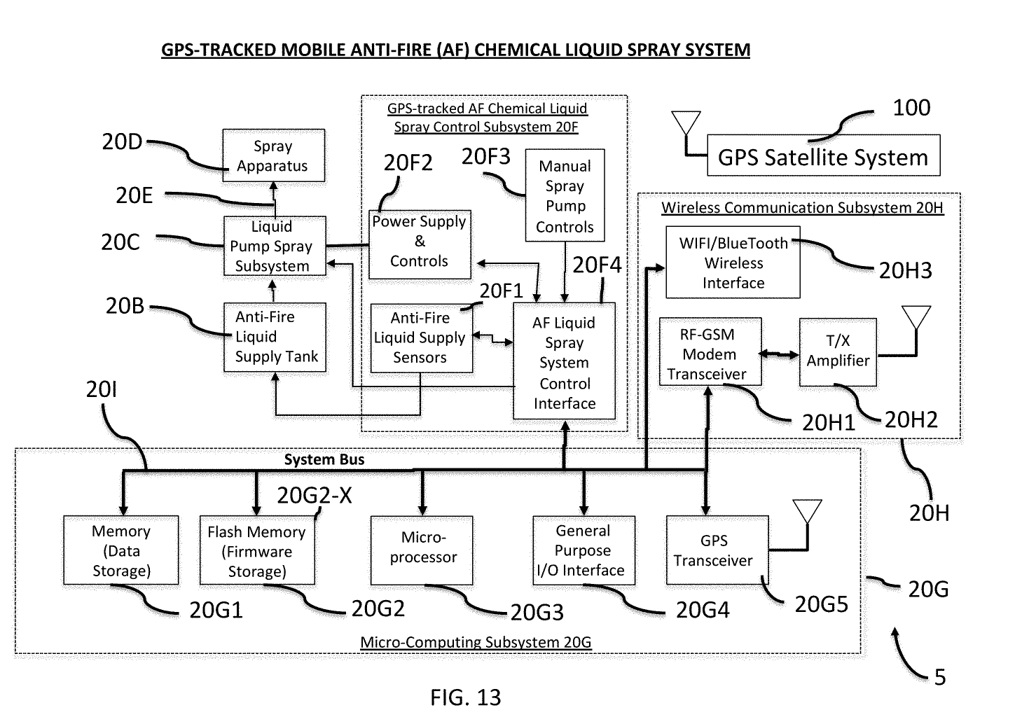

As shown in FIG. 4, the system network architecture shows many different kinds of users supported by mobile computing devices 11 running the mobile application 12 of the present invention, namely: the plurality of mobile computing devices 11 running the mobile application 12, used by fire departments and firemen to access services supported by the system network 1; the plurality of mobile computing systems 11 running mobile application 12, used by insurance underwriters and agents to access services on the system network 1; the plurality of mobile computing systems 11 running mobile application 12, used by building architects and their firms to access the services supported by the system network 1; the plurality of mobile client systems 11 (e.g. mobile computers such as iPad, and other Internet-enabled computing devices with graphics display capabilities, etc) used by spray-project technicians and administrators, and running a native mobile application 12 supported by server-side modules, and the various illustrative GUIs shown in FIGS. 12 through 13D, supporting client-side and server-side processes on the system network of the present invention; and a GPS-tracked anti-fire (AF) liquid spraying systems 20, 30, 40 and 50 for spraying buildings and ground cover to provide protection and defense against wild-fires.

In general, the system network 1 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (DOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C, Java, PHP, Python, Google's GO, and other computer programming languages known in the art. Preferably, the system network is deployed as a three-tier server architecture with a double-firewall, and appropriate network switching and routing technologies well known in the art. In some deployments, private/public/hybrid cloud service providers, such Amazon Web Services (AWS), may be used to deploy Kubernetes, an open-source software container/cluster management/orchestration system, for automating deployment, scaling, and management of containerized software applications, such as the mobile enterprise-level application 12 of the present invention, described above.

### Specification of System Architecture of an Exemplary Mobile Smartphone System Deployed on the System Network of the Present Invention

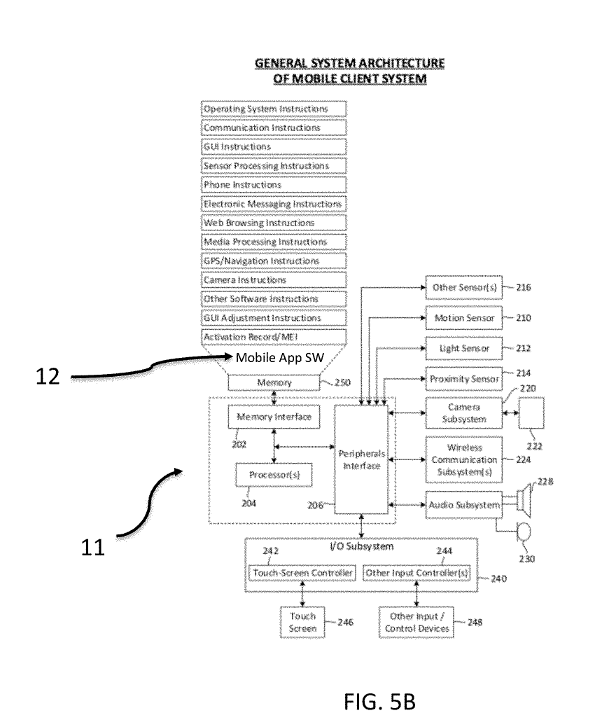

FIG. 5A shows an exemplary mobile computing device 11 deployed on the system network of the present invention, supporting conventional wildfire alert and notification systems (e.g. CAL FIRE® wild fire notification system 14), as well as the mobile anti-fire spray management application 12 of the present invention, that is deployed as a component of the system network 1.

FIG. 5B shows the system architecture of an exemplary mobile client computing system 11 that is deployed on the system network 1 and supporting the many services offered by system network servers 9A, 9B, 9C, 9D, 9E. As shown, the mobile smartphone device 11 can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g. GPS receiver), a temperature sensor, a biometric sensor, a gyroscope, or other sensing device, to facilitate related functionalities. A camera subsystem 220 and an optical sensor 222, e.g. a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g. infrared) receivers and transmitters. The specific design and implementation of the communication subsystem 224 can depend on the communication network(s) over which the mobile device is intended to operate. For example, the mobile device 11 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 11 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile smartphone device 11 can be found in U.S. Pat. No. 8,631,358 incorporated herein by reference in its entirety.

### Different Ways of Implementing the Mobile Client Machines and Devices on the System Network of the Present Invention

In one illustrative embodiment, the enterprise-level system network is realized as a robust suite of hosted services delivered to Web-based client subsystems 1 using an application service provider (ASP) model. In this embodiment, the Web-enabled mobile application 12 can be realized using a web-browser application running on the operating system (OS) (e.g. Linux, Application IOS, etc) of a mobile computing device 11 to support online modes of system operation, only. However, it is understood that some or all of the services provided by the system network 1 can be accessed using Java clients, or a native client application, running on the operating system of a client computing device, to support both online and limited off-line modes of system operation. In such embodiments, the native mobile application 12 would have access to local memory (e.g. a local RDBMS) on the client device 11, accessible during off-line modes of operation to enable consumers to use certain or many of the system functions supported by the system network during off-line/off-network modes of operation. It is also possible to store in the local RDBMS of the mobile computing device 11 most if not all relevant data collected by the mobile application for any particular fire-protection spray project, and to automatically synchronize the dataset for user's projects against the master datasets maintained in the system network database 9C1, within the data center 8 shown in FIG. 4. This way, when using an native application, during off-line modes of operation, the user will be able to access and review relevant information regarding any building spray project, and make necessary decisions, even while off-line (i.e. not having access to the system network).

As shown and described herein, the system network 1 has been designed for several different kinds of user roles including, for example, but not limited to: (i) public and private property owners, residents, fire departments, local, county, state and federal officials; and (ii) wild fire suppression administrators, contractors, technicians et al registered on the system network. Depending on which role, for which the user requests registration, the system network will request different sets of registration information, including name of user, address, contact information, etc. In the case of a web-based responsive application on the mobile computing device 11, once a user has successfully registered with the system network, the system network will automatically serve a native client GUI, or an HTML5 GUI, adapted for the registered user. Thereafter, when the user logs into the system network, using his/her account name and password, the system network will automatically generate and serve GUI screens described below for the role that the user has been registered with the system network.

In the illustrative embodiment, the client-side of the system network 1 can be realized as mobile web-browser application, or as a native application, each having a “responsive-design” and adapted to run on any client computing device (e.g. iPhone, iPad, Android or other Web-enabled computing device) 11 and designed for use by anyone interested in managing, monitoring and working to defend against the threat of wild fires.

### Specification of the Fire-Protected Shed Structure of the Present Invention

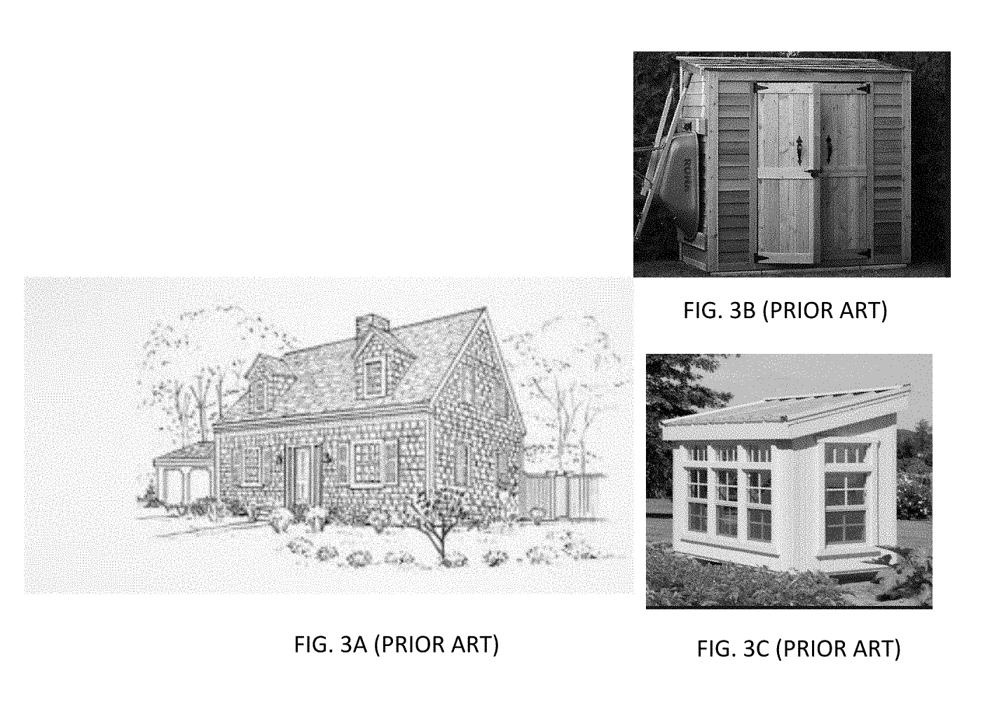

FIG. 6 shows the house in FIG. 3A, on which property the fire-protected shed structure of the present invention 50 is installed for purposes of illustration. FIG. 7 shows in greater detail the fire-protected shed structure 50 installed on a parcel of real property, with the GPS-tracked anti-fire liquid spraying system 5 shown in FIG. 4 removed from storage in the shed structure 50, and place outside thereof for use in spraying clean anti-fire chemical liquid on the exterior surfaces of the house, as well as wood decking, fences, shrubs and other combustible materials on the property prior to the arrival of any wildfire. The purpose of this spray treatment is to render all spray-treated surfaces fire-protected against wildfires, by virtue of the free-radical chemical-reaction breaking characteristics of the anti-fire chemical inhibitor liquid used during spray treatment.

FIG. 8 shows the fire-protected shed structure 50 of the present invention during the final stages of construction with its front fire-rated steel door 50D removed off its hinges to permit viewing to the interior of the shed structure. As shown, the fire-protected shed structure 50 comprises several different types of panel structures built around a Class-A fire-protected wood-frame structure 51 shown being constructed in FIGS. 9A and 9B: a multi-layered wall structure 50A illustrated in FIG. 10A; a multi-layered roof structure 50B illustrated in FIGS. 10B and 10B1; a multi-layered flooring structure 50C illustrated in FIG. 10C; and a fire-rated door structure 50D. Each of these fire-protected shed components will be described in greater detail in the FIGS. 9 through 9H, during the various stages of the construction process.

FIGS. 9A and 9B show the Class-A fire-protected wood-frame structure 51 is constructed from: (i) Class-A fire-protected 2×4 wood studs dip-infused as taught in U.S. patent application Ser. No. 15/829,914, to construct side wood frame panels 51A, 51B, 51C and 51D; (ii) Class-A fire-protected 2×6 wood joints dip-infused in clean fire inhibiting chemical (CFIC) liquid, as taught in U.S. patent application Ser. No. 15/829,914, to construct floor wood frame panel structure 52, with a Class-A fire-protected layer of plywood or OSB 52 also treated with clean fire inhibiting chemical (CFIC) liquid as taught in U.S. patent application Ser. No. 15/829,914; and (iii) Class-A fire-protected 2×6 wood joints 51E dip-infused in clean fire inhibiting chemical (CFIC) liquid, as taught in U.S. patent application Ser. No. 15/829,914, to construct wood frame roof structure, covered with a Class-A fire-protected layer of plywood or OSB 52 also treated as taught in pending U.S. patent application Ser. No. 15/829,914, incorporated herein by reference.

As shown in FIGS. 9C and 9D, the Class-A fire-protected wood-frame structure 51, with floor structure 52, is then provided with a metal-foil radiation-reflective sheathing (i.e. radiant-energy insulation) or covering 54 installed on the exterior side of the wood framing using nails or staples.

FIG. 9E shows some DensGlass® brand fiberglass mat gypsum sheathing 53A and 53E being applied to the interior side of the wood frame structure 51 during the construction phase of the shed structure, to provide thermal-energy insulation to the interior fire-protected storage space within the shed structure 50. Such thermal energy insulation sheathing is used to finish the entire walls and ceiling of the shed structuring using conventional nails or staples fastened to the wood studs of the Class-A fire-protected wood framework 51.

As shown in FIG. 9F, HardieBacker® 500 fiber cement panels 55A, 55B, 55C and 55D from James Hardie Building Products, Inc. are installed over the metal-foil radiation-reflective sheathing or covering 54. Then over these fiber cement panels 55A, 55B, 55C and 55D, HardiePanel® fiber cement vertical siding 56 is mounted, for an attractive appearance. Then, a one-hour steel firedoor 50D is installed in the front side of the fire-protected wood framework 51, as shown in FIG. 9G. Thereafter, HardieBacker® fiber cement trim 57 is used to provide trim around the shed structure, as shown in FIG. 9H. Thereafter, Tilcor® Class-A fire-protected stone-coated steel roofing tile system 58 is mounted on the metal-foil heat reflective sheathing on the roof panel 59.

FIG. 10A shows the multi-layered structure of the wall construction of the fire-protected shed structure 50. As shown, the (side) wall construction 50A comprises: (i) a 2×4 Class-A fire-protected stud-based wood frame studs 51A, 51B, 51C, 51D to provide wood wall frameworks; (ii) fiberglass mat gypsum sheathing 53A, 53B, 53C, 53D mounted upon a 2×4 Class-A fire-protected stud-based wood frame studs 51A, 51B, 51C, 51D, to provide thermal-energy insulation to maintain the interior temperature within the shed relatively cool, despite extreme temperatures outside while wildfires are circling the shed structure; (iii) a metal-foil radiation-reflective layer 54 applied to the exterior surface of the wood-framed studs, to provide insulation against radiant-energy heat transfer; (iv) HardieBacker® fiber cement paneling 55A, 55B, 55C, 55D applied over the metal-foil radiation-reflective layer; and (v) HardiePanel® fiber cement vertical siding 56 applied over HardieBacker® fiber cement paneling 55A, 55B, 55C, 55D.

FIG. 10B shows the multi-layered structure of the roof construction of the fire-protected shed structure of the present invention 50. As shown, the roof construction 50B of the present invention comprises: (i) a wood framed roof structure made from 2×6 Class-A fire-protected wood joists, 51E; (ii) a layer of Class-A fire-protected plywood or OSB 59 mounted on the wood-framed roof structure; (iii) a layer of metal-foil heat reflective layer 55E applied over the Class-A fire-protected plywood 59 to provide radiant energy insulation; (iv) a Tilcor® multi-layered roofing system 58 mounted over the metal-foil radiation-reflective layer; and (v) fiberglass mat gypsum sheathing 53E mounted upon a 2×6 Class-A fire-protected wood frame joists 51E, to provide thermal energy insulation to maintain the interior temperature within the shed relatively cool, despite extreme temperatures outside while wildfires are circling the shed structure.

U.S. Pat. No. 6,557,313 to Alderman, incorporated by reference, discloses a blanket insulation material with reflective sheet and air space, which can be used as the radiation-reflective layer material 55A, 55B, 55C, 55D, 55E to provide heat insulated wall, roof and floor structures within the fire-protected shed structure 50 of the present invention.

FIG. 10B1 shows the multi-layer Class-A fire-protected roofing system 58 employed in the fire-protected shed structure 50 of the present invention. As shown, the roofing system 58 comprises: (i) a base steel layer 58A, to which a first and second zincalume layers 58B and 58C are bonded; (ii) primer layers 58D and 58E applied to the first and second zincalume layers 58B and 58C, respectively; (iii) an acrylic base coat 58F applied over the top primer layer 58D; (iv) a natural stone chip layer 58G applied over the acrylic base coat 58F, and (v) an acrylic overglaze 58H applied over the natural stone chip layer 58H. These multi-layer steel-based stone-chip covered tile structures are stacked upon each other to provide a Class-A fire-protected stone-coated pressed-steel roofing tile/panel system, offered by the Ross Roof Group, under the Tilcor® brand.

FIG. 10C shows the multi-layered floor construction 50C of the fire-protected shed structure 50. As shown, the floor construction 50C comprises: (i) a wood frame flooring structure formed from Class-A fire-protected 2×6 joists 52B dip-infused as taught in U.S. patent application Ser. No. 15/829,914; a ¾″ Class-A fire-protected plywood or OSB flooring panel 52A treated as taught in U.S. patent application Ser. No. 15/829,914, and mounted to the wood frame flooring joists 52B to create a flooring structure; and (ii) a concrete base structure 52C supported on the ground surface, beneath and closely interfaced with the flooring structure 50C to prevent fire from moving beneath the floor system.

FIG. 10D shows the fire-rated door construction used in the fire-protected shed structure of the present invention. This door structure, including its frame, will be made of metal, designed and manufactured to provide at least 1 hour fire-wall rating, to provide the necessary fire-protection from this point of access in the fire-protected shed structure 50 of the present invention.

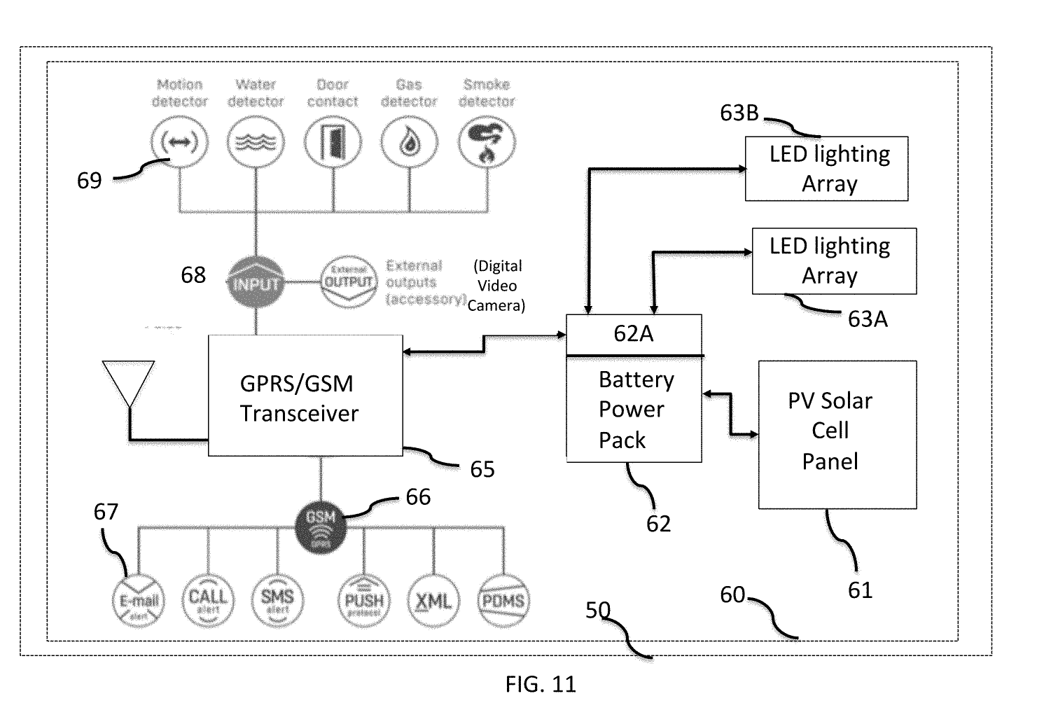

FIG. 11 describes the solar-powered LED lighting system 60, including its integrated GPRS/GSM transceiver and input sensors supported within the fire-protected shed structure 50 of the present invention. As shown in FIG. 11, the solar-powered LED lighting system 60 comprises: a photo-voltaic solar panel 61 electrically connected to a battery power storage module 62, for storing DC electrical power generated by the PV solar panel 61 in response to incident sunlight shining on the PV solar panel, and supplying DC electrical power to a set of LED lighting arrays 63A, 63B electrically connected to the battery power storage module 62, under the control of the control module 62; a GPRS/GSM transceiver 65 electrically powered by the batter power storage module 62, under control module 62A, and having an antenna structure mounted outside the shed, and a plurality of environmental sensors 69, driven by input ports 68, including a motion sensor, a water detector, a door contact sensor, a gas (e.g. CO) detector, a temperature sensor, and smoke detector; and a plurality of output devices 67, driven by GSM 66, including email server, call alert, SMS alert, PUSH protocol, XML and PDMS. During operation, the LED lighting arrays 63A, 63B will be mounted within the interior of the shed, along with all other components in the system 60, except the PV solar panel 61 which will be mounted on the roof of the shed structure. The control module 62 interiorly mounted components

As shown in FIG. 11, the LED lighting system 60 may include devices such as a digital video camera, and other instruments, remotely accessible by the homeowner before, during and after wildfire emergency conditions, using the mobile application 12 supported on the mobile computing device 11 deployed on the system network 1, shown in FIG. 4.

By virtue of the wild-fire protection shed system 50 of the present invention, the interior storage space within the shed (e.g. for bicycles, motorcycles, skiis, picture frames, artwork, any personal property that can fit into the space of the shed) will remain relatively cool to the outside temperature during a wildfire, and free from smoke, so as to protect any personal property and valuables that may be put into the shed prior to a wildfire which are known to approach a region very quickly, sometimes less than 30 minutes. Provided with radiant energy and thermal energy insulation layers, the interior of the fire-protected shed system of the present invention should safely protect possessions stored therein during any wildfire. As the exterior is coated with concrete panels, fire should not pentrate the Class-A fire-protected lumber framework around which the shed structure has been constructed. The Class-A fire-protected roofing system will provide fire protection from the roof side of the shed structure, and steel 1-hour fire door will keep fire and smoke out of the interior from the doorway side.

The internal temperature and smoke sensors can continue to operate and record the internal temperature of the fire-protected property storage shed during a wildfire, despite disruption of electrical power in the vicinity which is likely to disrupt cellular communications in many instances. This can serve as proof that the fire protected shed in fact performed as intended during wildfires. Video cameras may also be installed and used for remote monitoring of property before the occurrence of wildfires, and possibly during depending on the state of communications around the deployed shed structure. There will be many ways to use the wild-fire protected shed given the benefit of the present invention disclosure, and many modifications will readily come to mind for those having the benefit thereof.

### Specification of the Mobile GPS-Tracked Anti-Fire (AF) Liquid Spraying System of the Present Invention

FIG. 12 shows a mobile GPS-tracked anti-fire (AF) liquid spraying system 5 supported on a set of wheels 20A, having an integrated supply tank 20B and rechargeable-battery operated electric spray pump 20C, for deployment at private and public properties having building structures, for spraying the same with environmentally-clean anti-fire (AF) liquid using a spray nozzle assembly 20D connected to the spray pump 20C by way of a flexible 20E.

FIG. 13 shows the GPS-tracked mobile anti-fire liquid spraying system 5 of FIG. 6A as comprising a number of subcomponents, namely: a GPS-tracked and remotely-monitored AF chemical liquid spray control subsystem 20F; a micro-computing platform or subsystem 20G interfaced with the GPS-tracked and remotely-monitored AF chemical liquid spray control subsystem 20F by way of a system bus 201; and a wireless communication subsystem 20H interfaced to the micro-computing platform 20G via the system bus 201. As configured, the GPS-tracked mobile anti-fire liquid spraying system 20 enables and supports (i) the remote monitoring of the spraying of anti-fire (AF) chemical liquid from the system 5 when located at specific GPS-indexed location coordinates, and (ii) the logging of all such GPS-indexed spray application operations, and recording the data transactions thereof within a local database maintained within the micro-computing platform 20G, as well as in the remote network database 9C1 maintained at the data center 8 of the system network 1.

As shown in FIG. 13, the micro-computing platform 20G comprises: data storage memory 20G1; flash memory (firmware storage) 20G2; a programmable microprocessor 20G3; a general purpose I/O (GPIO) interface 20G4; a GPS transceiver circuit/chip with matched antenna structure 20G5; and the system bus 201 which interfaces these components together and provides the necessary addressing, data and control signal pathways supported within the system 5.

As shown in FIG. 13, the wireless communication subsystem 20H comprises: an RF-GSM modem transceiver 20H1; a T/X amplifier 20H2 interfaced with the RF-GSM modem transceiver 20H1; and a WIFI and Bluetooth wireless interfaces 20H3.

As shown in FIG. 13, the GPS-tracked and remotely-controllable anti-fire (AF) chemical liquid spray control subsystem 20F comprises: anti-fire chemical liquid supply sensor(s) 20F1 installed in or on the anti-fire chemical liquid supply tank 20B to produce an electrical signal indicative of the volume or percentage of the AF liquid supply tank containing AF chemical liquid at any instant in time, and providing such signals to the AF liquid spraying system control interface 20F4; a power supply and controls 20F2 interfaced with the liquid pump spray subsystem 20C, and also the AF liquid spraying system control interface 20F4; manually-operated spray pump controls interface 20F3, interfaced with the AF liquid spraying system control interface 20F4; and the AF liquid spraying system control interface 20F4 interfaced with the micro-computing subsystem 20G, via the system bus 201. The flash memory storage 20G2 contains microcode that represents a control program that runs on the microprocessor 20G3 and realizes the various GPS-specified AF chemical liquid spray control, monitoring, data logging and management functions supported by the system 5.

In the preferred embodiment, the environmentally-clean anti-fire (AF) chemical liquid is preferably Hartindo AF31 Total Fire Inhibitor, developed by Hartindo Chemicatama Industri of Jakarta, Indonesia, and commercially-available from Newstar Chemicals (M) SDN. BHD of Selangor Darul Ehsan, Malaysia, http://newstarchemicals.com/products.html. When so treated, combustible products will prevent flames from spreading, and confine fire to the ignition source which can be readily extinguished, or go out by itself. In the presence of a flame, the chemical molecules in both dry and wet coatings, formed with Hartindo AF31 liquid, interferes with the free radicals (H+, OH−, O) involved in the free-radical chemical reactions within the combustion phase of a fire, and breaks these free-radical chemical reactions and extinguishes the fire's flames.

Modifications to the Present Invention which Readily Come to Mind

The illustrative embodiments disclose the use of clean anti-fire chemicals from Hartindo Chemicatama Industri, particular Hartindo AAF31, for clinging to the surfaces of wood, lumber, and timber, and other combustible matter, wherever wild fires may travel. However, it is understood that alternative clean anti-fire chemical liquids may be used to practice the various wild fire suppression methods according to the principles of the present invention.

While the shed structure shown herein was of a general trapezoidal geoemetry, it is understood that the size and dimensions of the shed structure can be virtually any size that may fit on ones yard, and transported using conventional means and/or carriers.

These and other variations and modifications will come to mind in view of the present invention disclosure.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1. A wild-fire protected shed structure for installation on a parcel of real property, or within a garage, and having a fire-protected internal storage space for storing and protecting diverse items of personal property during raging wild-fires, said wild-fire protected shed structure comprises:
a frame structure constructed from Class-A fire-protected lumber, and having an interior side, and an exterior side;
radiant energy insulation installed on the exterior side of said frame structure, for insulation to radiant energy sources located outside of said wild-fire protective shed structure;
thermal energy insulation installed on the interior side of said wood frame structure, so as to provide thermal insulation to the interior of said wild-fire protected shed structure to maintain the interior temperature relatively cool, despite extreme temperatures outside while wildfires are circling said wild-fire protected shed structure;
fiber cement panels installed over said radient energy insulation so as to protect said radient energy insulation from wirefires;
a fire-door installed in a front door way portion of said frame structure providing access to said fire-protected internal storage space, and providing essential fire-protection from said door way portion of said wildfire-protected shed; and
a fire-protected roofing system mounted on the roof portion of said wild-fire protected shed structure.

2. The wild-fire protected shed structure of claim 1, which further comprises:
fiber cement siding mounted over said fiber cement panels.

3. The wild-fire protected shed structure of claim 1, wherein said radiant energy insulation comprises metal-foil radiation-reflective sheathing.

4. The wild-fire protected shed structure of claim 1, wherein said thermal energy insulation comprises fiberglass gypsum sheathing.

5. The wild-fire protected shed structure of claim 1, wherein said frame structure is constructed from Class-A fire-protected lumber.

6. The wild-fire protected shed structure of claim 1, which further comprises a solar-powered LED lighting system.

7. The wild-fire protected shed structure of claim 6, wherein said solar-powered LED lighting system comprises: a photo-voltaic solar panel electrically connected to a battery power storage module, for storing DC electrical power generated by the PV solar panel in response to incident sunlight shining on the PV solar panel, and supplying DC electrical power to a set of LED lighting arrays electrically connected to the battery power storage module, under the control of the control module.

8. The wild-fire protected shed structure of claim 7, wherein said solar-powered LED lighting system further comprises a radio transceiver electrically powered by the batter power storage module, under control module, and having an antenna structure mounted outside the shed, and a plurality of environmental sensors; and a plurality of output devices.

9. The wild-fire protected shed structure of claim 8, wherein said plurality of environmental sensors include one or more selected from the group consisting of a motion sensor, a water detector, a door contact sensor, a gas detector, a temperature sensor, and smoke detector; and wherein said plurality of output devices are selected from the group consisting of an email server, call alert, SMS alert, PUSH protocol, XML and PDMS.

10. The wild-fire protected shed structure of claim 7, wherein said LED lighting arrays are mounted within the interior of the shed, along with all other components in the system, except the PV solar panel are mounted on the roof of said wildfire protected shed structure.
